(19) United States
(12) Patent Application Publication
(10) Pub. No.: US 2010/0125343 A1
(43) Pub. Date: May 20, 2010

(54) Complex Servo Control System

(75) Inventors: Shih Che Hung, Hsinchu City (TW); Yung Shen Lee, Taipei City (TW)

Correspondence Address: DITTHAVONG MORI & STEINER, P.C., 918 Prince Street, Alexandria, VA, 22314, US

(73) Assignee: Micro-Star Int'l Co., Ltd., Jung-He City (TW)

(21) Appl. No.: 12/399,169

(22) Filed: Mar. 6, 2009

(30) Foreign Application Priority Data
Nov. 14, 2008 (TW) 097144228

(51) Int. Cl. G05B 19/02

(52) U.S. Cl. 700/3

(57) ABSTRACT

A complex servo control system includes a host control end, a servo master controller, and a plurality of servo streams. The host control end sends control commands, and the servo master controller receives the control commands to generate corresponding control signals. Each control signal includes an identification code and a setting value. The servo streams are electrically connected to the servo master controller in parallel. Each of the servo streams includes a plurality of servos and each of the servos has a given an identification code. The servo master controller sends the control signals to one of the servo streams according to the identification code carried by the control signals, and the control signals are then received and sent downwards in sequence by the servos of the servo stream. When the identification code carried by control signals match the given identification code of one of the servo, the servo having the identification code activates according the setting value.

### CROSS-REFERENCES TO RELATED APPLICATIONS

This non-provisional application claims priority under 35 U.S.C. §119(a) on patent application Ser. No(s). 97144228 filed in Taiwan, R.O.C. on 2008/11/14, the entire contents of which are hereby incorporated by reference.

### BACKGROUND OF THE INVENTION

1. Field of the Invention

The present invention relates to control of a servo, and more particularly, to a complex servo control system and a method thereof for servos with combined serial and parallel control architectures.

2. Related Art

In a robot or an automated machine, servos are used to actuate components to operate according to the required displacement and timing, thereby conducting the actuated components to achieve the preset operation. The more complex actions of the robot or the automatic machine have, the more servos are required. In the prior art, the control architectures of the servos may be classified into parallel control architecture and serial control architecture, according to the connections with the host controller.

Referring to FIG. 1, a system block diagram of the parallel control architecture in the prior art is shown. In the parallel control architecture, pins of the servo 1 are directly connected to pins of the servo master controller 2. The servo master controller 2 encodes control commands of a host control end 3 into control signals, and sends control signals to the designated servo 1 through the corresponding pins to control the operation of the servo 1. Also, the servo master controller 2 receives feedback signals from the servo 1 and sends feedback signals.

In the parallel control architecture, the pins of the servo 1 are directly connected to the pins the servo master controller 2. Therefore, all of the servos 1 will directly and simultaneously receive the control signals from the servo master controller 2 and operate at the same time. However, in the parallel control architecture, every servo 1 occupies one set of the pins of the servo master controller 2 to allow every controlled servo 1 to receive the control signals respectively. Thus, the amount of the servos 1 connected to the servo master controller 2 is limited to the amount of the pins of the servo master controller 2. When the amount of the servos 1 required for controlling the robot or the automatic machine increases, a servo master controller with more output pins should be utilized to control more servos 1.

FIG. 2 illustrates a system block diagram of serial control architecture. In the serial control architecture, the first servo 1 is directly connected to the servo master controller 2, while the other the servos 1 are connected to the former servo 1 in sequence, thereby forming a servo stream allowing the control signals to be transmitted therein. Each of the servos 1 has a given identification code. The control command issued by the host control end 3 will include an identification code to conduct the operation of a designated servo 1. The servo master controller 2 sends the control commands by transmitting the control signals in the form of packets. Each of the packets carries an identification code and one or more setting values. The control signals are transmitted through the servo stream and pass each of the servos 1 one by one. After receiving the packets, each of the servos 1 determines if the identification code in the packets matches the given identification code of the servo 1. If it matches the identification code of the current servo 1, the servo 1 will execute the setting values within the packet. If it does not match, the packet will be sent to the next servo 1. Under such an architecture, one set of pins of the servo master controller 2 are required to be connected to the first servo 1; therefore, there is no limitation caused by the number of pins of the servo master controller 2 when increasing the amount of the servos 1. There will be a delay time between the point in time at which the control commands are issued by the servo master controller 2, and the point in time that each of the operated servos 1 receives the control commands. Using such architecture of serial control, the delay time between sending and receiving the control command will be higher for those servos 1 arranged at the end of the servo stream. If the delay time is too large, operations of all the servos 1 will be imprecise. In addition, if there are too many servos, the servo stream will be too long. It will cause the signal intensity remaining at the end section of the servo stream to decay below a threshold value at which it can still drive the servo 1 precisely, thereby failing to drive precisely the servo 1 located at the end of the servo stream.

Each of the parallel and serial control architectures has its own advantages. However, some different problems also exist in the two control architectures when the amount of the servos 1 is increased. Nowadays, a robots or automatic machine aims at operations in multiple degrees of freedom, and consequently more servos 1 are needed. Therefore, keeping the advantages of the above two architectures and decreasing the negative effects resulting from the aforementioned problems has become an urgent technical issue requiring a reliable solution.

### SUMMARY OF THE INVENTION

In the prior art, the parallel and serial control architectures cause different problems, making it difficult to increase the number of the servos they use. To solve the aforementioned problems, the object of the present invention is to provide a complex servo control system to increase the number of servos efficiently.

In view of the object of the present invention, the present invention provides a complex servo control system, which includes a host control end, a servo master controller, and a plurality of servo streams. The host control end issues control commands. The servo master controller is electrically connected to the host control end for receiving the control commands and generating corresponding control signals. The control signal includes an identification code and a setting value. The servo streams are connected to the host control end in parallel. Each of the servo streams includes a plurality of servos, and each servo has a given identification code. The servo master controller sends a control signal to the designated servo stream according to the identification code, and then the control signal is received and sent downwards in sequence by the servos in the servo stream. When the identification code carried by the control signal matches the given identification code of one of the servo, the servo executes the setting value.

The present invention further provides a complex servo control system, which includes a host control end, a servo master controller, at least one servo stream and at least one stream branch. The host control end issues control commands. The servo master controller is connected to the host control end for receiving the control commands and generating corresponding control signals. Each of the control signals includes identification code and a setting value. Each of the servo stream and the branch servo stream includes a plurality of servos, and each of the servos has a given identification code. The servo stream is connected to the servo master controller, while the stream branch is connected to one of the servos of the servo stream. The servo master controller sends a control signal to the servo stream or the stream branch according to the identification code carried by the control signal, and then the control signals is received and sent downwards in sequence by the servos of the servo stream or the stream branch. When the identification code carried by the control signal matches the identification code, the servo executes the setting value.

The advantage of the present invention is that, the parallel and serial control architectures is combined in the complex servo control system of the present invention combines, therefore increasing the number of servos under the same limitation of connection amounts of the host control end is achieved without over-increasing the transmitting path length which transmits the control signals. Meanwhile, the present invention avoids the conventional problems caused when the parallel and serial control architectures increase the number of servos in the prior art.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 is a block diagram illustrating a parallel control architecture in the prior art;

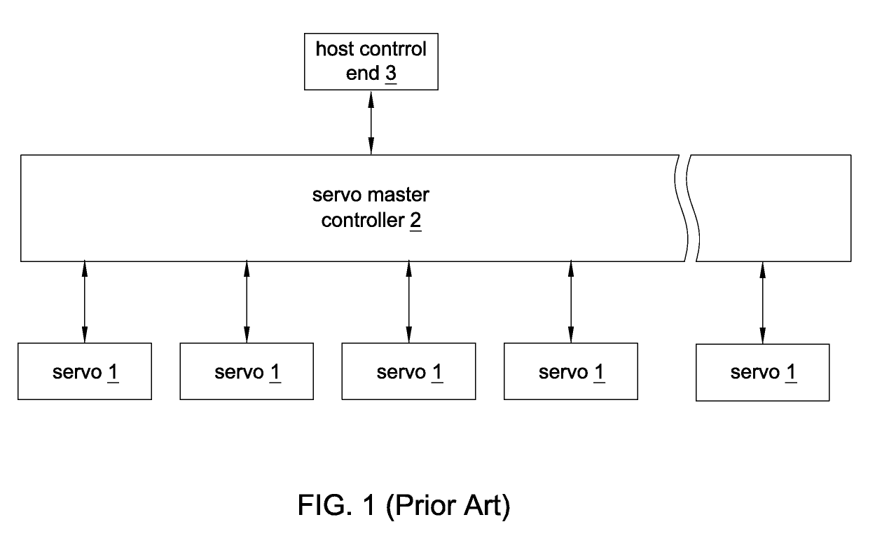

FIG. 2 is a block diagram illustrating a serial control architecture in the prior art;

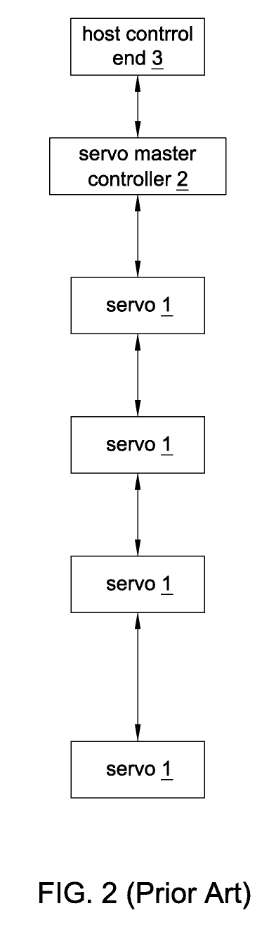

FIG. 3 is a block diagram illustrating an embodiment of the present invention;

FIG. 4 is a block diagram illustrating a control device according to the embodiment of the present invention; and

FIG. 5 is a simplified block diagram according to the embodiment of the present invention.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

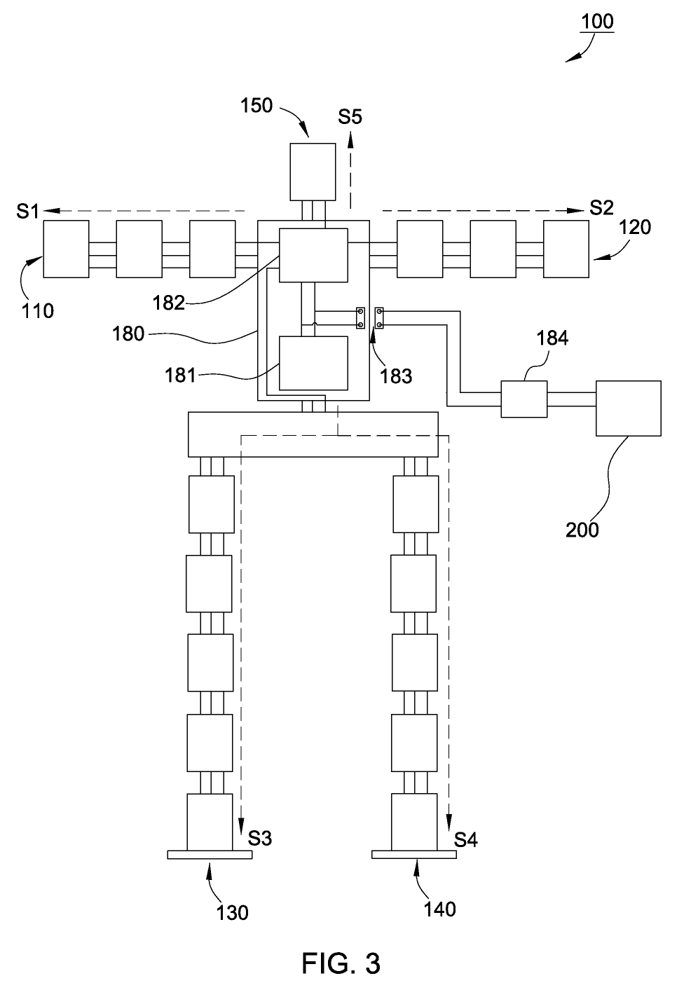

Referring to FIG. 3, a complex servo control system 100 according to an embodiment of the present invention is shown. The complex servo control system 100 is applied to a robot, a robotic arm, or an automatic machine. The complex servo control system 100 includes a control device 180 and a plurality of servo streams 110, 120, 130, 140, 150. Each of the servo stream 110, 120, 130, 140, 150 includes a plurality of servos connected in serial, such that each servo stream 110,120,130,140, 150 forms a signal transmitting path S1, S2, S3, S4, S5 to transmit the control signals. The servo streams 110, 120, 130, 140, 150 are connected to the control device 180 in parallel, such that each is able to receive the control signals issued by the control device 180.

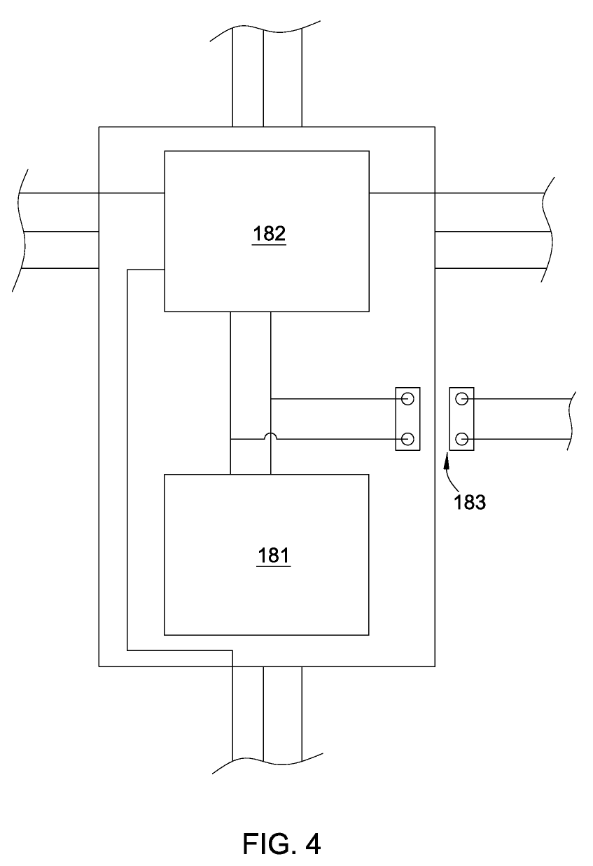

Referring to FIG. 3 and FIG. 4, the control device 180 includes a host control end 181 and a servo master controller 182. The host control end 181 executes a preloaded a control program to issue the control commands in sequence according to preset commands or user-input commands. The servo master controller 182 is electrically connected to the host control end 181 through a serial interface for bidirectional communications. The serial interfaces of the host control end 181 and the servo master controller 182 is electronically connected to a conversion interface 183 at the same time, wherein the conversion interface 183 is a serial-to-parallel interface (UART, Universal Asynchronous Receiver/Transmitter). Thus, the host control end 181 and the servo master controller 182 may be connected to a computer host 200 through the conversion interface 183, and the computer host 200 may rewrite the control program or preset commands of the host control end 181, or the computer host 200 may directly issue the control command to the servo master controller 182. Meanwhile, the computer host 200 may retrieve the servo information fed back from the host control end 181 or the servo master controller 182. Between the computer host 200 and the conversion interface 183, a voltage level shifter 184 is utilized to resolve the different operating voltages between interfaces of the computer host 200 and the conversion interface 183.

Referring to FIG. 3 and FIG. 4, the servo master controller 182 receives the control command issued by the host control end 181 and generates the corresponding control signals. The corresponding control signals will be sent to the designated servo stream through the serial interface, so as to control the operation of one or more designated servo.

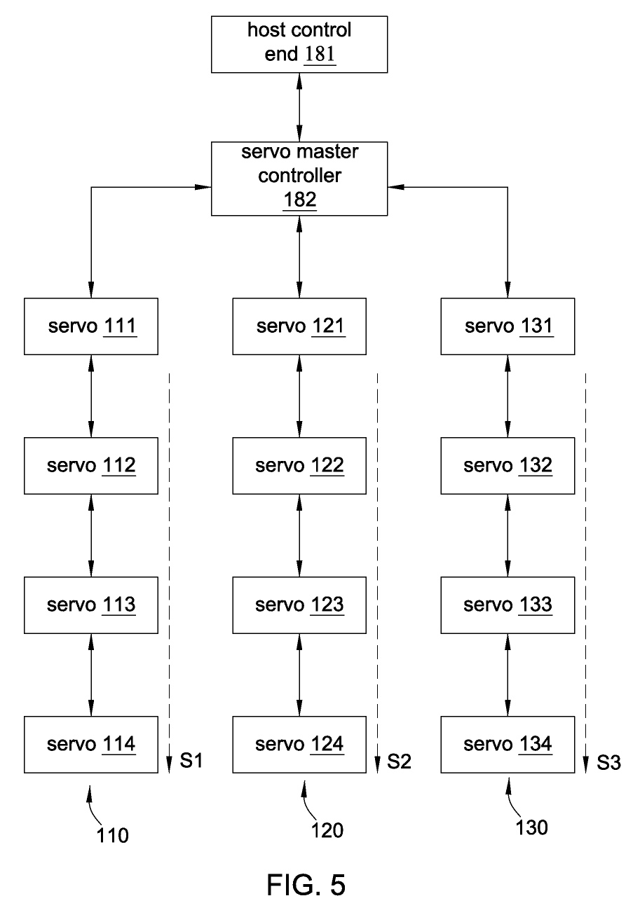

Referring to FIG.5, a simplified block diagram according to the embodiment of the present invention is shown. In FIG. 5, only three servo stream 110, 120, 130 are shown for illustration. In the actual implementation, the amount of the servo streams which may be used depends on the number of pins of the servo master controller 182. The servo streams 110, 120, 130 are connected to the servo master controller 182 in parallel. Each of the servo streams 110, 120, 130 is connected to one set of the pins of the servo master controller 182. Here the servo streams 110, 120, 130 are defined as the first servo stream 110, the second servo stream 120, and the third servo stream 130. The first servo stream 110, the second servo stream 120, and the third servo stream 130 are connected to different serial port pins of the servo master controller 182, in order to facilitate bidirectional communications.

Every servo stream includes a plurality of servos connected in serial, and every servo has a given with identification code. For example, in the embodiment, the first servo stream 110 has four servos 111, 112, 113, 114 connected in serial, the format of the given identification code for every servo may be “(first servo stream, first/second/third/fourth servo)”; but it is not limited to this format. The second servo stream 120 and the third servo stream 130 may have their servos 121, 122, 123, 124, 131, 132, 133, 134 to be given a similar format of given identification code. When the host control end 181 issues a control command to any of the servos 111, 112, 113, 114 of the first servo stream 110, the control command will also designate which servo is about to operate. Namely, aside from controlling the setting value of the servo, the control command also comprises an identification code of the controlled servo. As mentioned above, the identification code may include a servo code of the servo, and a servo stream code of the servo stream to which the servo belongs. After the control command is received by the servo master controller 182, the servo master controller 182 will encode the control command into a control command packet and outputs through designated serial port pins according to the servo stream assigned by the identification code. When the control command packet is sent to the servo stream, the servos will receive the control command packet in sequence and analyze it to confirm if the carried identification code matches the given identification code of the servo. If the identification code carried in the control command packet does not match, the servo will not operate and will send the control command packet downward to the next servo. If the identification code carried in the control command packet matches, the servo will further analyze the setting value carried in the control command packet, and then execute the operation designated by the host control end 181.

For instance, to control the operation of the third servo 113 of the first servo stream 110, the control command includes the identification code indicating the first servo stream 110 and the third servo 113; furthermore, the control command also includes the setting value (such as output displacement and output direction), which is designated to be executed. After the control command is sent from the host control end 181 to the servo master controller 182, the servo master controller 182 will issue the control command packet through the serial port connected with the first servo stream 110. The control command packet will then be received by the first servo 111 and the identification code will be compared. If the identification code does not match the given identification code of the first servo 111, the control command packet will be sent downward by the first servo 111 and be sent to the second servo 112. Similarly, the control command packet will be sent by the second servo 112, to the third servo 113. When the third servo 113 makes a comparison to confirm that the identification code carried in the control command packet matches the given identification code of the third servo 113, the setting value carried in the control command packet will be further executed by the third servo 113. Similarly, every servo will send a packet of status information to the host control end 181, the packet of status information is sent through the servo master controller 182. The host control end 181 will thus be able to monitor the current status of every servo. Aside from the current status information of the servo, the packet of status information also includes the given identification code of the feedback servo, so that the host control end 181 will be able to confirm the source of the packet of status information.

Regarding to the data format of the control command, every control command packet includes data such as a header, an setting value, identification code and a checksum code (Check Sum). TABLE 1 below shows a basic format of the control command packet. The control command packet is composed by a plurality of bytes of data. The data packet size of the control command packet depends on the setting value and the identification code carried and transmitted therein. Therefore there is no limitation in data packet size (the amount of the bytes).

TABLE 1

| Initial Byte | Middle Byte | | Ending Byte |
|---|---|---|---|
| Header | Setting value | Identification code | Check Sum |

Within the packet format shown in TABLE 1, an initial byte (or bytes), of every packet mainly constitutes the header, which is used by the servo to find the initial point of every packet in a string of continuous serial messages. The last byte (or bytes), is used to carry the checksum code to ensure the correctness of the packet content. The checksum code may be obtained by simple calculations of the data carried within the middle byte.

The middle bytes constitute the major message carried in every packet. The middle bytes include at least the setting value and the identification code. The number bytes constituting the setting value and the identification code is not limited, as long as the bytes amount of the setting value and the identification code is sufficient to completely transmit the messages. Furthermore, the sequence of the setting value and the identification code is not limited either. It is even possible to arrange the columns of the setting value and the identification code so that they are interlaced with each other in the packet.

TABLE 2

| High Nibble | Low Nibble |
|---|---|
| Servo stream Number | Servo Number |

TABLE 2 shows an example of the identification code, in which the identification code is divided into two sections. If the identification code is represented by one byte, the two sections will be a High Nibble and a Low Nibble. The High Nibble may be filled with the servo stream number, while the Low Nibble may be filled with the servo number (the sequence of the servo arranged in the servo stream). For instance, the third servo 113 of the first servo stream 110 may be filled with (1, 3), in which the sequence of the servo stream number and the servo number is not limited to TABLE 2. The identification code is not limited to the representation of one single byte. Moreover, specific identification code may be preset without being repeating with the assigned identification code of any servo. This specific identification code may be used to conduct the operation of all of the servos at the same time.

The setting value may be in various formats, because the operation types that the servo is requested to execute will affect significantly the appearance format of the setting value contained in the control command packet. In general, the setting value mainly includes two types of information, including the operation mode and the target value. The operation mode may include an ON/OFF mode, a mode of designating operation displacement, a continuous operation mode, a parameter setting mode, etc. As long as the operation mode is different, the input target value will be in a different format. Meanwhile the servo will switch to the designated operation mode first, and then execute the designated operation according to the target value.

As explained above, TABLE 3 illustrates the complete format of the control command packet:

TABLE 3

| Initial Byte | Middle Byte | | | | Ending Byte |
|---|---|---|---|---|---|
| Header | Operation | Target | Servo stream | Servo | Checksum |
| | Mode | Value | Number | Number | code |

The target value of the packet in TABLE 3 is not limited to one value; a plurality of target values may also be carried within the packet. Furthermore, the columns arranged by the middle byte are not limited to the format shown in TABLE 3; a random sequence may also be arranged.

Since the control command packet does not always issue commands to a single servo, some types of control command must control a plurality of servos each having the same given identification code. In such a system, the middle byte control command packet will need an additional column to indicate the number of servos, as shown in TABLE 4 below:

TABLE 4

| Initial | | | | | | Ending |
|---|---|---|---|---|---|---|
| Byte | Middle Byte | | | | | Byte |
| Header | Operation | Target | Number of | Servo | Servo | Checksum |
| | Mode | Value | Servos | stream | Number | code |
| | | | | Number | | |

Similarly, every servo may periodically issue packet of status information (or issue it after receiving the control command), and send it along the servo stream to the servo master controller 182. The packet of status information sent to the host control end will have the format shown in TABLE 5 below:

TABLE 5

| Initial Byte | Middle Byte | | Ending Byte |
|---|---|---|---|
| Header | Identification code | Status Information | Checksum code |

In the packet shown in TABLE 5, one or more of the initial byte packets is mainly the header, which is used for the servo to find the initial point of every packet within a string of serial messages. The last byte (or bytes), will be filled with a checksum code, so as to ensure the correctness of the packet content. The checksum code may be obtained by means of a simple calculation of the data carried within the middle byte. Moreover, the assigned header of the packet of status information is different from the header of the control command packet, so that the servo may identify if the packet is the packet of status information, and send it to the servo master controller 182. The middle bytes constitute the primary information carried in every packet of status information. In TABLE 5 the middle bytes include status information, and the given identification code of the servo. The number of bytes in the status information and the given identification code is not limited, as long as the number of bytes is sufficient to transmit the status information completely. Furthermore, the sequence of the status information and the given identification code is not limited either. It is even possible to arrange the columns of the status information and the given identification code to interlace with each other in the packet.

After retrieving the status information from the servo master controller 182, the host control end 181 will be able to read the current status of the servo according to the status information. The status information may include parameter settings, current location, current rotation speed and current temperature, etc. Meanwhile, the carried identification code will be used to confirm the source of the status information.

Briefly, the present invention discloses a combination of parallel and serial control architectures. The present invention divides the conventional long string of the servo stream into a plurality of shorter servo streams, and these shorter servo streams are connected in parallel, so as to avoid insufficient signal intensity when the control signals are sent to the end of the servo stream. Meanwhile, the present invention reduces the delay time incurred when transmitting different control signals in the servo stream. The present invention keeps the delay time within an acceptable range, so that the operations of a plurality of servos precisely operate at the same time. The a plurality of servo stream are connected to the servo master controller in parallel, in order to resolve the problem in the prior art that the serial port pins of the servo master controller are not connected sufficiently directly with all the servos in parallel. The present invention also reduces the cable arrangement problem when the servos are connected with the servo master controller in parallel.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A complex servo control system, comprising:
a host control end, for issuing a control command;
a servo master controller, electrically connected to the host control end, for receiving the control command and generating a corresponding control signal comprising an identification code and an setting value; and
a plurality of servo streams, electrically connected to the servo master controller in parallel, and each of the servo streams including a plurality of servos, and each of the servos having a given identification code;
wherein the servo master controller sends the control signal to a designated one of the servo stream according to the identification code, and the control signal is received and sent downwards in sequence by the servos of the servo stream, and when the identification code carried by the control signal matches the given identification code, the servo executes the setting value.

2. The complex servo control system as claimed in claim 1 further comprising a serial-to-parallel interface for connecting the host control end and the servo master controller to a computer host.

3. The complex servo control system as claimed in claim 1, wherein the identification code comprises a servo code of one of the servos, and a servo stream code of the servo stream provided with the servo matching the servo code.

4. The complex servo control system as claimed in claim 1, wherein the servo sends the control signal to the next servo of the servo stream of the same servo stream if the identification code carried by the control signals does not match the given identification code of the servo.

5. The complex servo control system as claimed in claim 1, wherein the setting value comprises at least one operation mode and at least one target value.

6. The complex servo control system as claimed in claim 1, wherein the control signal is a control command packet including initial byte, middle byte and ending byte, while the initial byte is a header, the middle byte includes the setting value and the given identification code, and the ending byte is a checksum code.

7. The complex servo control system as claimed in claim 1, wherein each of the servos issues at least one packet of status information to a control device, wherein the packet of status information includes current status information of the servo and the given identification code of the servo.

8. The complex servo control system as claimed in claim 7, wherein the packet of status information includes a initial byte, a middle byte, and an ending byte, while the initial byte is a header, the middle byte includes the identification code and a status value, and the ending byte is a checksum code.
